(19) United States
(12) Patent Application Publication
(10) Pub. No.: US 2018/0147715 A1
(43) Pub. Date: May 31, 2018

(54) HANDLE

(71) Applicants: Steve Promo, Moran, MI (US); Jeffrey E. Promo, Ankeny, IA (US)

(72) Inventors: Steve Promo, Moran, MI (US); Jeffrey E. Promo, Ankeny, IA (US)

(21) Appl. No.: 15/827,219

(22) Filed: Nov. 30, 2017

Related U.S. Application Data
(60) Provisional application No. 62/427,949, filed on Nov. 30, 2016.

(51) Int. Cl. B25G 1/10

(52) U.S. Cl. CPC B25G 1/102

(57) ABSTRACT

A handle is used with a tool or other device to provide an ergonomic connection and gripping portion for the tool. The handle includes a first end that is canopy shaped, onion shaped, or otherwise not ball shaped to allow for the end to be placed in a palm and to spread force about a greater area of the palm. A transition portion connects the canopy portion to a grip portion. The transition portion allows for a hand that is surrounding the grip portion to rest comfortably against or adjacent the canopy portion to provide for even greater comfort in use of the handle. The grip portion can include finger grooves. A cavity is included to attach the handle to the tool.

### CROSS-REFERENCE TO RELATED APPLICATIONS

This application claims priority under 35 U.S.C. § 119 to provisional application Ser. No. 62/427,949, filed on Nov. 30, 2016, the contents of which are hereby incorporated for all purposes.

### FIELD OF THE INVENTION

The present disclosure relates generally to handles. More particularly, but not exclusively, the invention is directed towards an ergonomic handle for use with various tools, shovels, and/or hand-held devices.

### BACKGROUND OF THE INVENTIONS

Tools and other hand-held devices have been known and used. For example, tools, such as shovels, rakes, brooms, and generally any other device for yard work, cleaning, construction, painting, and other industries provide for devices that have a length to aid in the work performed. Such length allows for easier work based upon the reaching of the tools afforded by the length, as well as by the leverage provided due to the length of the tool and the amount of force that is able to be obtained. Still further, the tool heads attached to the tools provide unique functions, such as providing a larger surface area for digging or providing a specific tool head for a specific function.

The tools often have a handle with a grip or other member to provide support and other functions. Such handles may be a device positioned on an elongated member, or simply the elongated member. Some handles include an attached portion that is plastic and that provides a grip. The grip can be plastic, rubber, metal, or otherwise and provide a place to grasp and exert a force. The grip can also provide features such as a hook or other area for hanging the tool. Still other grips and handles as well as combinations of the same provide for easier use and/or storage of the tools. However, while handles and grips are known, there are still issues. Many grips are not ergonomic in that they do not provide the best dispersion of force throughout the hand of a user. This can create physical injury, both short and long term. The shape of the handles can also be limiting on their function, and can limit the force exerted by the tool. Other issues exist.

Therefore, there is a need in the art for an improved tool handle and/or grip that overcomes or improves on the issues in the art. This includes improvement on handles that are used with tools and that can be set at the time of the making of the tool or can be added after the fact.

### BRIEF SUMMARY OF THE INVENTION

It is therefore a primary feature, object, and/or advantage of the disclosure to improve on and/or overcome the issues in the art.

It is another object, feature, and/or advantage of the disclosure to provide a handle that improves on the grip of a device utilizing the handle.

It is yet another object, feature, and/or advantage of the disclosure to provide a handle for use with a tool that spreads the force applied to the handle over a larger area on a hand or other appendage in communication with the handle.

These and/or other objects, features, and advantages of the invention will be apparent to those skilled in the art. The invention is not to be limited to or by these objects, features and advantages. No single embodiment need provide each and every object, feature, or advantage.

According to some aspects of the disclosure, a handle for use with a tool or other device is provided. The handle includes a first end having a canopy shape terminating at a grip portion, said grip portion extending generally away from the canopy shaped first end and terminating in a distal end, and a cavity at the distal end and extending toward the canopy shaped end for connecting the handle to a tool.

According to additional aspects of the disclosure, a handle for use with a tool or other device is provided, and includes a first end having a canopy shape with a substantially planar portion at a pinnacle location; a grip portion extending from the first end, the grip portion including one or more finger grooves and a cavity therein for receiving a portion of the tool; and a transition portion between the first end and the grip portion, wherein the transition portion extends from an outer perimeter of the canopy shape and inward towards the grip portion.

According to yet additional aspects of the disclosure, a method for using a handle with a tool includes providing a handle including a canopy shaped first end and a grip portion extending therefrom; attaching the handle to the tool; placing the canopy shaped first end in a palm of a hand; placing the grip in a palm of an opposite hand; and providing a force with both of the hands in a manner to utilize the tool. The canopy shaped first end will spread the force of the tool about the palm of the hand to reduce the stress thereon.

### BRIEF DESCRIPTION OF THE DRAWINGS

FIG. 1 is a top perspective view of a handle according to aspects of the disclosure.

FIG. 2 is a bottom perspective view of the handle.

FIG. 3 is a bottom end view of the handle showing a cavity of the handle.

FIG. 4 is a side elevation view of the handle.

FIG. 5 is a top plan view of the handle.

FIG. 6 is a bottom plan view of the handle.

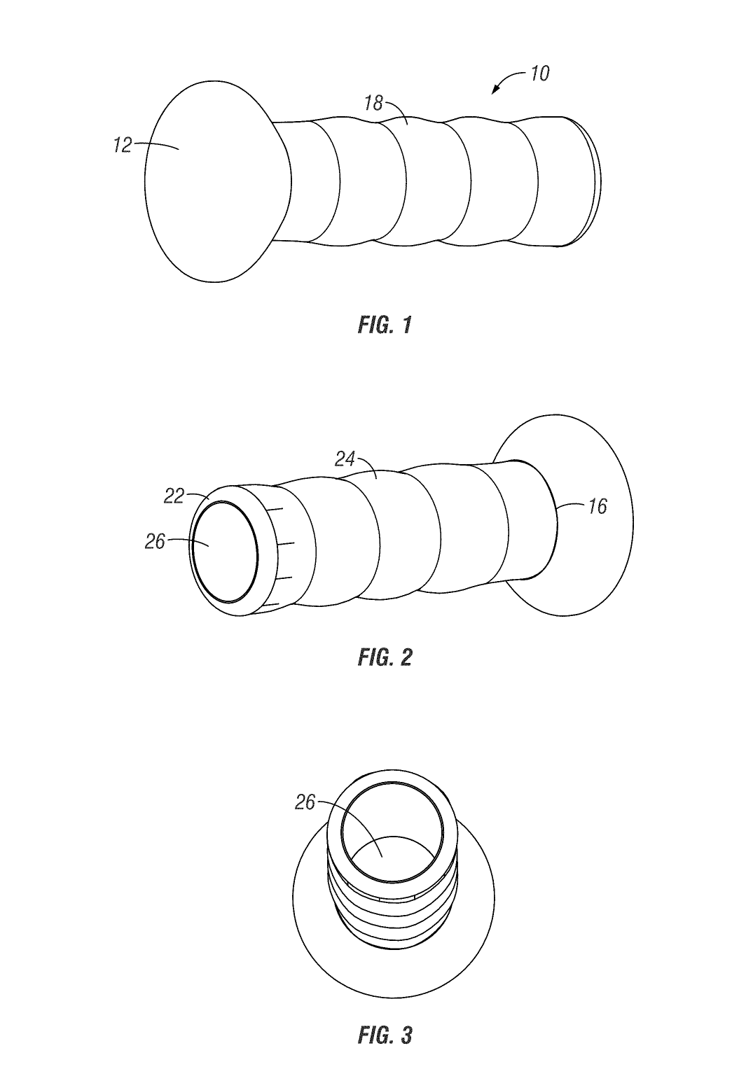

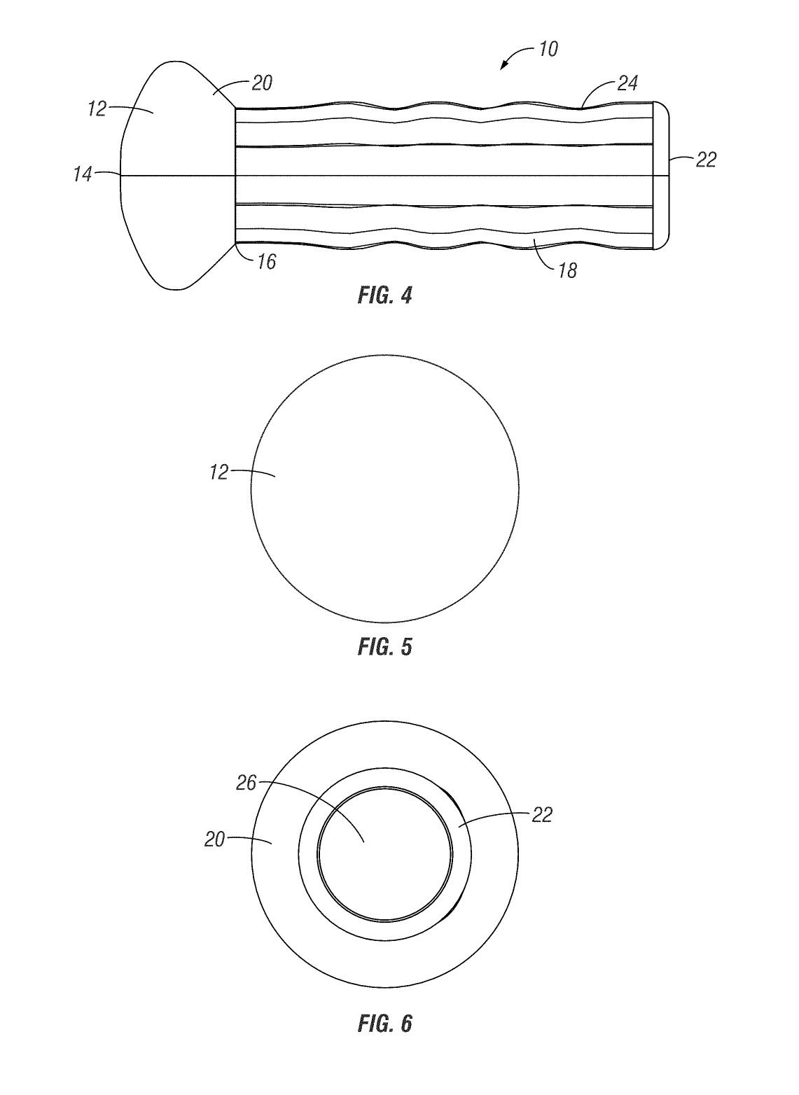

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE INVENTION

The present disclosure includes a novel handle or grip member 10 for attaching to an elongated handle member of a tool. The tool for which the aspects of the present disclosure can be used are not to be limiting to the present disclosure. However, for purposes of context, it is to be contemplated that the aspects of the present disclosure can be used generally with any tool, including but not limited to construction tools, yard tools, cleaning tools, and the like. Such tools can include shovels, rakes, brooms, painting apparatus, pool cleaning and/or maintenance tools, fall retrieval tools, or generally any other member in which an elongated device has a functioning end and is gripped at an opposite end and/or along the length of the elongated device. As will be understood, the handle 10 according to aspects of the present disclosure can be used with such an elongated member in order to provide for numerous advantages for using any of the tools or other devices. As disclosed, the handle 10 according to aspects of the present disclosure can be used with an elongated member. Such an elongated member can take many forms. Such forms may include, but are not limited to, elongated wooden members, metal members, composite members, classic members, or some combination thereof. Furthermore, such an elongated member can be telescoping or otherwise adjustable in length to provide for additional benefits and/or length of the tool of the elongated member. Other aspects of the elongated member can provide for stiffening or other support portions, rotational portions, as well as other protruding members therefrom, such that can be used with the tool to provide for easier use thereof. It is to be appreciated that, while some tools and/or elongated members have been described for exemplary in environmental purposes in the present disclosure, these are not to be limiting on the aspects of the present disclosure, and are otherwise included for context.

Therefore, aspects of the present disclosure are directed towards an improved and novel handle member 10 for use with an elongated member. As will be understood, the handle member 10 according to aspects of the invention can be attached, affixed, or otherwise connected and/or associated with the elongated member. For example, the handle 10 of the present disclosure can be positioned at one end of the elongated member, such as the end opposite the tool head or use of the elongated member. This can be positioned by at least partially covering an end of the elongated member with the handle 10. Still further, additional attaching means, such as adhesives, mechanical attachments, friction, over molding, and the like are all ways of attaching the handle 10 to the elongated member, as will be understood.

The handle 10 of the present disclosure includes numerous features that provide unique, novel, and/or improvements over existing handles in the art. For example, the handle includes a first end 12 which is canopy, mushroom, or onion-shaped in that it provides a cascading shape from a pinnacle portion 14 of the end 12 and cascading away therefrom. The shape maybe be considered onion-like in that it is in between a squash ball and tear drop, as opposed to traditional round or ball-shaped members. This end 12 may be referred as to a first or knob end. The cascading or canopy knob end has a terminal point 16 in which the portion of the handle is connected to a grip portion 18 extending generally from the knob end 12. The pinnacle portion can be curved and can also include a portion that is substantially flat or planar in nature. There is a transition portion 20 in between the knob end 12 and the grip portion 18, which may be referred to a shoulder portion. The shoulder portion 20 transitions from the wider portion of the knob end and towards the narrower grip portion, which includes a smaller diameter.

The transition and/or shoulder portion 20 between the canopy knob end 12 and the grip portion 18 may take many forms, including, but not limited to, a rounded shoulder, concaved portion, substantially straight transition, or some combination thereof. The shoulder end or transition portion of the handle 10 allows for the knob and of the handle to have a substantially larger diameter than that of the grip portion 18, while maintaining a one-piece configuration of the handle 10.

The grip portion 18 extends a distance and terminates at a distal end 22 away from the knob portion 12 of the handle 10. The length of the grip portion 18 can vary according to type of tool to be used with the handle 10, and is not to be limiting on the present disclosure. For example, the length of the grip portion 18 of the handle 10 can be longer for longer tools or can be shorter depending on the type of tool that the handle is associated with. The grip portion 18 can include one or more finger grooves 24 along the length of the grip portion 18 to aid in gripping of the handle 10. As shown in the Figures, the finger grooves 18 can be positioned generally on one side and/or can be include multiple sides. For example, according to some aspects of the disclosure, it is contemplated that one side of the grip portion include multiple finger grips for the digits of the hand, while the opposite end provides at least one finger groove for the thumb to allow for the wrapping of the fingers and thumb around the grip portion of the handle. However, the size, shape, and/or number of finger grooves along the length of the grip are not to be limiting to the present disclosure. However, the integral finger and/or thumb grooves along the length of the grip portion 18 helps the heel of the hand of a user against the knob end, which further enhances the grip and reduces the hands slippage during forward direction of a tool, such as a shovel impacting the ground. For example, if a left hand is gripping the grip and a right hand is on the knob end of the handle, the hands will be used in conjunction to provide for greater force and contacting the ground and utilizing the tool to which the handle is attached. However, this is to be shown for exemplary purposes and is not to be limiting.

Still further, the distal end 22 of the grip portion 18 may include a cavity 26 extending back towards the knob end 12. The cavity 26 may extend generally any length towards the knob end and may actually extend beyond the knob end to provide a cavity extending through the entire length of the handle 10. However, according to some aspects of the disclosure, the cavity 26 extending from the distal end will terminate before the knob end, such as to create a hollow portion within the handle 10. The cavity 26 extending through the handle body will allow the handle to be positioned generally on and/or around an elongated member for use therewith. This will allow the handle 10 to be attached to an elongated member for at least temporary connection thereto. As mentioned, the handle can be attached to the elongated member in many ways, including friction fit and/or adhesives. It is also envisioned that the cavity includes threaded portions to allow the handle 10 to be screwed or connected to a corresponding threaded portion of a tool for connection thereto. Therefore, the handle can be positioned on the elongated member and be connected therewith via the friction fit due to the size of the cavity, and it is also contemplated that an adhesive, such as glue or other adhesive be included on the handle or within the cavity to further attach the handle to the elongated member. Once the elongated member is positioned within the cavity of the handle, a mechanical means, such as the screws, pins, or the like could also be included with the handle to provide a more permanent connection between the handle and the elongated member.

As the cavity can be of various sizes and lengths, in other words diameter in length in the handle, it is contemplated that the handle can be used with generally any type of elongated member. This includes that the product can be an aftermarket product which is used to replace an existing handle on an elongated tool body. Still further, this allows for easy installation over an elongated tool body that can be affixed thereto to provide for a stable connection therewith to provide for easier use of the tool.

It is further contemplated that the material of the handle takes many forms. According to some aspects, the material of the handle may be molded from a UV resistant silicone based compound. Such a material provides for increased or improved grip versus vinyl or form handle grips currently available. However, it is to be appreciated that this not be limiting and it is contemplated that generally any material, such as metal, plastics, rubbers, silicones, and/or any combination thereof, such as composites, be utilized to form the handle of the present disclosure. It is a material that maybe soft yet firm maybe chosen to aid in the use of the tool. Such a material can provide for max or increase shock absorption, while still providing a higher durability due to the firmness. Furthermore, it is to be appreciated that the different portions of the tool handle be formed of different materials to provide for both a soft shock absorbent portion of the knob end while also a firm, durable rest of the handle to provide for a combined material that increases the ascetics and use of the handle.

The unique and novel aspects of the handle provided advantages is over existing handles and tools. For example, the canopied and/or onion-like shape of the knob end of the handle makes the handle easier to grip the end with fingers when the knob end is in the palm of the hand of a user. The larger diametered knob end spreads the force over a larger area of the palm of the hand than a round ball shape, which allows for the force to be dispersed over a larger area of the hand, which reduces pain, both on the short-term end and the long term. This also provides increased ergonomic features for use of the handle, such as by producing the likelihood of sustained injury via use of the tool with the handle of the present disclosure. The spreading of the force over a larger area of the palm reduces bruising, blisters, and other unwanted injuries cause by use of a tool. Still further, the shape is more comfortable for resting on the shovel or other tool handle in a vertical position.

Therefore, a unique and novel handle has been shown and described herein. It is to be appreciated that various aspects of the handle, including sizes of the portions, shapes of the portions, and/or any other portion of the handle disclosed herein are to be included and contemplated as part of the present disclosure. While a canopied-shape knob end is shown and described, it is to be appreciated that this canopied and cascading knob end can be larger diametered and can be greater in the ratio of the diameter of the knob end to the grip portion in order to be greater or provide increased dispersement of force upon a palm of the user. Still further, the knob end may be flatter in portions to allow for gripping of the knob end while also providing the dispersed area applied towards the handle. As mentioned, the grip portion can include one or more finger grooves to allow for easier grip thereof and can increase being increased in length so as to allow for the grip portions to be used with both hands when shoveling or using the elongated member of the tool to pick or lift an amount of material or otherwise use the device in other manners.

What is claimed is:

1. A handle for use with a tool or other device, the handle comprising:
a first end having a canopy shape terminating at a grip portion;
said grip portion extending generally away from the canopy shaped first end and terminating in a distal end; and
a cavity at the distal end and extending toward the canopy shaped end for connecting the handle to a tool.

2. The handle of claim 1, wherein the grip portion includes one or more finger grooves positioned along the length of the grip portion.

3. The handle of claim 1, wherein the canopy shaped first end is not ball-shaped.

4. The handle of claim 1, wherein the canopy shaped first end includes a curved surface.

5. The handle of claim 4, wherein the curved surface includes a substantially planar section at a pinnacle point of the canopy shaped first end.

6. The handle of claim 1, further comprising a transition portion between the first end of the handle and the grip portion.

7. The handle of claim 6, wherein the transition portion is angled from an outer portion of the canopy shaped first end and towards the grip portion.

8. The handle of claim 7, wherein the cavity ends before the transition portion.

9. The handle of claim 1, wherein the cavity includes internal threads.

10. The handle of claim 1, further comprising an adhesive within the cavity to aid in connecting the handle.

11. A handle for use with a tool or other device, the handle comprising:
a first end having a canopy shape with a substantially planar portion at a pinnacle location;
a grip portion extending from the first end, the grip portion including one or more finger grooves and a cavity therein for receiving a portion of the tool; and
a transition portion between the first end and the grip portion, wherein the transition portion extends from an outer perimeter of the canopy shape and inward towards the grip portion.

12. The handle of claim 11, wherein the cavity extends from a distal end of the grip portion and towards the first end.

13. The handle of claim 12, wherein the cavity ends before the transition portion.

14. The handle of claim 11, wherein the one or more finger grooves extend about a periphery of the grip portion.

15. The handle of claim 11, wherein the first end, grip portion, and transition portion form a one-piece, integral composition.

16. The handle of claim 11, wherein the cavity includes internal threads for attaching to a tool or device.

17. The handle of claim 11, wherein the cavity is circular-shaped.

18. The handle of claim 11, wherein the handle comprises a UV resistant silicone based compound.

19. The handle of claim 11, wherein the canopy shape of the first end includes a diameter that is larger than the grip portion.

20. A method for using a handle with a tool, comprising:
providing a handle including a canopy shaped first end and a grip portion extending therefrom;
attaching the handle to the tool;
placing the canopy shaped first end in a palm of a hand;
placing the grip in a palm of an opposite hand; and
providing a force with both of the hands in a manner to utilize the tool;
wherein the canopy shaped first end will spread the force of the tool about the palm of the hand to reduce the stress thereon.
